(19) United States
(12) Patent Application Publication
(10) Pub. No.: US 2014/0167676 A1
(43) Pub. Date: Jun. 19, 2014

(54) BATTERY PACK HAVING A SEPARATE POWER SUPPLY DEVICE FOR A WIRELESS COMMUNICATION DEVICE OF THE BATTERY PACK

(71) Applicant: ROBERT BOSCH GMBH, Stuttgart (DE)

(72) Inventor: Juergen Mack, Geoppingen (DE)

(21) Appl. No.: 14/123,796

(22) PCT Filed: Apr. 12, 2012
(86) PCT No.: PCT/EP2012/056665

§ 371 Date: Feb. 28, 2014

(30) Foreign Application Priority Data
Jun. 6, 2011 (DE) 10 2011 076 963.3

(51) Int. Cl. H02J 7/02

(52) U.S. Cl. CPC H02J 7/025
USPC 320/101; 320/108

(57) ABSTRACT

A battery pack has at least one chargeable battery cell, an electrical interface for charging the battery pack on an external charging unit, a communication device for wireless communication with an external charging unit, and an energy supply device that is independent of the battery cell for the energy supply of the communication device during an initial communication with the external charging unit.

### BACKGROUND OF THE INVENTION

1. Field of the Invention

The present invention relates to a battery pack having a separate power supply device for a wireless communication device of the battery pack.

2. Description of the Related Art

Electric devices may be driven, using chargeable batteries or accumulators independently of external power sources. Depending on the application, both exchangeable battery packs or accumulator packs, and internal battery or accumulator cells, that are permanently installed in the device, are used. The charging of these electrical energy stores takes place using external charging units. In an inductive charging system, a magnetic field generated by a transmitting coil of a charging station is used for the power transmission between the charging station and the battery pack. The power received by the receiving unit of the battery pack is stored for the most part directly in the battery cells. A far lesser proportion of the transmitted power is needed by the receiving unit for its own use.

In order to charge the battery device, it is coupled in a suitable manner to the associated charging unit, which takes place, for instance, by putting the battery device into a corresponding accommodation of the charging station. However, in order for the power to be emitted from the charging station to the receiving unit, an inductive coupling is required, which is essentially developed in the form of two coils that are coordinated with each other and usually equipped with a core. The coupling, which is usually effective for relatively short distances of a few millimeters up to a few centimeters, may be extended still further by using a resonant embodiment of the device, while maintaining a relatively large power efficiency.

During the actual power transmission, the charging station and the battery pack communicate continuously with each other, whereby, with the use of the communication, the closing of the control loop is essentially implemented. In this context, the battery pack transmits certain charging parameters to the charging station. The charging parameters include current condition data of the respective battery, such as the battery voltage, the charging current or the battery temperature. These data are recorded in the battery pack and are transmitted to the charging station via an existing communication connection. In the case of an inductive charging system, this transmission typically takes place in wireless fashion. For this, the battery pack, besides a control device or a checking device, which records the respective charging parameters, also has an appropriate wireless communication device.

In the wireless communication between the battery pack and the charging station, the battery pack has to be cyclically pinged uninterruptedly, so that one may detect with certainty the insertion or the removal of the battery pack from the charging station. In this context, by the so-called “pinging” one may understand the emission of brief energy pulses or telegrams from the charging station to the battery pack. In the case of battery pack that is installed, it also replies using a corresponding telegram. For the initial communication between battery pack and charging station, which happens before the actual charging process, the communication device and the control device or checking device of the battery device require corresponding electrical energy. This energy may not be taken from the energy cells, since this could perhaps lead to a deep discharge of the battery cells, which is to be avoided unconditionally. In addition, it must be ensured that the communication still functions even in the case of a deeply discharged battery pack. For this reason, in the related art, above all, concepts are known in which, by the brief application of a continuous magnetic alternating field, or by emitting brief energy-rich pulses (so-called “pings”) the energy needed for the initial communication is transmitted to the battery device. These forms of implementation have above all the decisive disadvantage that the charging station steadily radiates a magnetic field, which leads to an unnecessary power consumption in the stand-by mode. In such embodiments, furthermore, a steady “pinging” is absolutely necessary to assure a sufficient battery pack detection.

### BRIEF DESCRIPTION OF THE INVENTION

It is therefore the object of the present invention to provide a possibility of initial communication between the battery pack and the charging station, without power being taken from the battery cells for this purpose, and without having to keep up a steady magnetic alternating field by the charging station.

According to the present invention, a battery device is provided having at least one chargeable battery cell, the battery device including an electrical interface for an external charging unit for charging the battery cell and a communication device for producing a communication connection to the external charging unit. It is further provided, in this instance, that the battery device include a separate power supply device for the communication device. Because of the separate power supply device, it is possible to operate the communication device of the battery device independently of the external power supply. Thereby it is no longer necessary steadily to supply power to the transmitting device of the charging station to assure the detection of the battery device. Rather, in the case in which no battery device is used, the charging station may now be operated in a power-saving ready mode. Since the communication device of the battery device, based on the separate power supply, is operated independently of the charging state of the battery cells, the communication with the charging station may also take place in response to a relatively deeply discharged battery cell, without the respective battery cell being damaged by a further removal of energy.

In one advantageous specific embodiment, it is provided that the power supply device includes an energy harvesting device and an energy store device. The energy harvesting device is designed, in this case, to obtain electrical energy from the surroundings of the battery device, while the energy store device is developed to store the electrical energy thus obtained.

A further specific embodiment provides that the energy harvesting device is developed to convert electromagnetic radiation acting upon the battery device into electric power. Since radiation energy, in general, is steadily available, it is optimally suitable for being used as an independent energy source for the energy supply of the communication device.

According to one additional specific embodiment, it is provided that the energy harvesting device includes a photovoltaic cell and/or a receiving antenna for electromagnetic radiation. Based on its relatively high efficiency, a photovoltaic cell, especially in a well-illuminated environment, represents a very suitable power source, for the purpose of providing a relatively large quantity of power for the communication device. Based on the electromagnetic radiation, that is available almost everywhere, a receiving antenna, by contrast, permits a continuous power generation.

According to another specific embodiment, the energy harvesting device is developed to convert the motion of the battery device into electrical energy. In this context, it is provided in one specific embodiment that the energy harvesting device includes a piezoelectric element which converts vibrations in the battery device into electrical energy, while the energy harvesting device, in an alternative specific embodiment, includes an electromagnetic generator, which converts motions of the battery device into electrical energy. The utilization of vibration energy and energy of motion represents a suitable form of power generation, particularly in the case of portable electric units with which the user works during operation. Moreover, this form of power generation has proven to be especially suitable for electric tools which, in their usual application, are exposed to vibrations or back and forth motions. In this context, piezoelectric elements are preferably used, in order to convert higher frequency vibrations into electrical energy, while electromagnetic generators are particularly effectively able to transform low-frequency vibrations and other motions of the electric unit into electrical energy.

One further specific embodiment provides that the energy harvesting device include a thermoelectric generator. With the aid of such a thermoelectric generator, a temperature difference may be transformed directly into an electric voltage. Consequently, the heat that comes up, for example, during the operation of the battery device, which would otherwise be dissipated into the environment unutilized, may be utilized effectively for charging the energy store device.

In yet another specific embodiment, it is provided that the electrical interface of the battery device is developed to receive energy from a corresponding electrical interface of the charging unit in a wireless manner. For the wireless energy transmission between the charging unit and the battery device one may basically use any suitable concept, such as an inductive, an electromagnetic or a capacitive energy transmission method. The wireless energy transmission makes possible a galvanic separation between the charging station and the battery device. Furthermore, the charging of the battery device is simplified thereby, since, when putting the battery device into the charging station, no special charging contact arrangement has to be considered. Rather, the battery device may be put into the charging cradle in various positions.

According to a still further specific embodiment, it is provided that the electrical interface is developed for producing an inductive coupling with the external charging unit. The inductive coupling between an inductive transmission coil and an inductive receiving coil enables a particularly suitable energy transmission method, since, in this case, energy is transmitted essentially only when the inductive receiving coil is located in the vicinity of the inductive transmission coil, i.e. when the battery device is actually put into the charging cradle.

A further specific embodiment also provides that the communication device be developed for producing a wireless communication connection with the external charging unit. The wireless communication connection permits the battery device to initiate a communication with the charging station even before it is put into the charging station. Furthermore, in this way a completely wireless charging system may be implemented, in which charging the battery cell is possible independently of the position of the battery device within the charging cradle.

In a further specific embodiment, it is provided that the communication device includes a modulator, for setting up a wireless communication connection in the ISM band. The ISM band permits a cost-effective and reliable bidirectional communication connection.

A further specific embodiment provides that the communication device is developed to transmit charging parameters of the battery cell, made available by the control device of the battery device, to the charging unit via the wireless communication connection. The control circuit is closed thereby in a wireless manner. The complete wireless coupling between the battery device and the charging unit increases the safety as well as the handling of the charging system, among other things.

Finally, according to an additional specific embodiment, it is provided that the energy supply device is developed to supply the control unit with electrical energy. This enables the battery device to transmit data, already at the initial communication with the charging unit, with the aid of which the charging unit is able to identify the battery device. Thus, it may be achieved, on the one hand, that the battery device is not erroneously charged at a charging unit that is unsuitable for it. On the other hand, with the aid of the initial identification, it may be achieved that the charging unit adjusts its charging behavior individually to different battery devices.

### BRIEF DESCRIPTION OF THE DRAWINGS

FIG. 1 shows a system including a battery device according to the present invention and an external charging station, the battery device including a communication device and a separate energy store device supplied with electrical energy via a photovoltaic energy harvesting device.

FIG. 2 shows an alternative specific embodiment of the battery device in FIG. 1, according to the present invention, the energy harvesting device including a piezoelectric element for generating electrical energy from vibrations of the battery device.

### DETAILED DESCRIPTION OF THE INVENTION

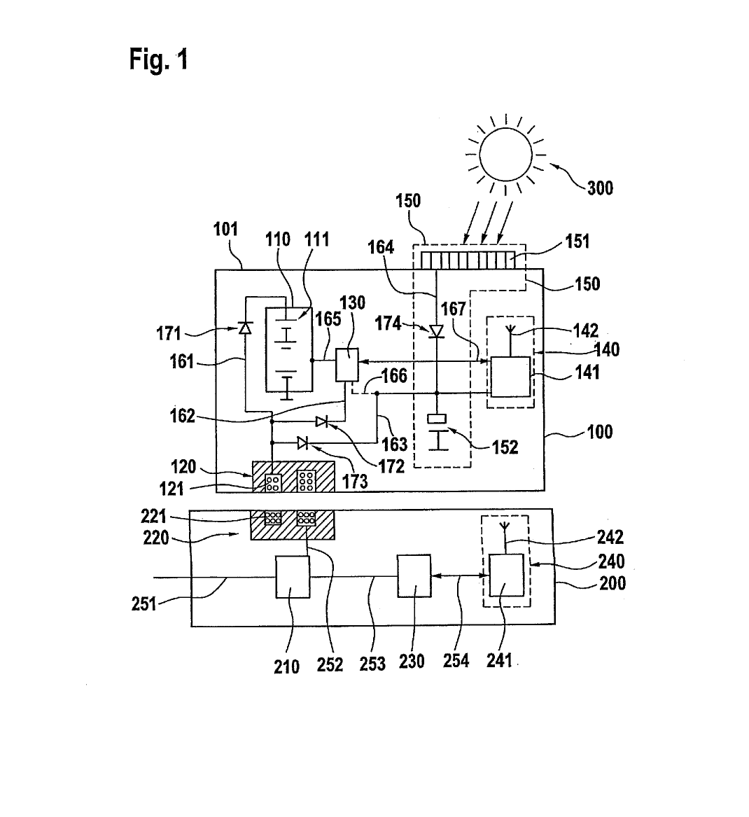

FIG. 1 shows a system made up of a battery device 100 having rechargeable battery cells, as well as an associated charging unit 200, which is developed in the form of a charging station 200 having an accommodation for battery device 100. Battery device 100 is, for instance, a so-called battery pack or accumulator pack, which may be used in a great variety of devices. Battery device 100 may also be developed, however, as a compact electrical unit having integrated battery cells, such as an electric toothbrush. As may be seen in FIG. 1, battery device 100 includes a first energy store device 110, which is particularly developed as a chargeable battery or accumulator, an electrical interface 120 for charging the first energy store device 110, a control or checking device 130 for ascertaining the charging parameters and the condition of the first energy store device, a communication device 140 for setting up a communication connection to the associated charging station 200. According to the present invention, battery device 100 also includes a separate energy supply device 150 for the independent energy supply of the communication device 140.

Energy store device 110 includes at least one chargeable battery cell 111. Depending on the requirements, a plurality of individual battery cells 111, as is the case in FIG. 1, may be connected in series, to achieve a desired power or voltage. As the battery cell, basically any suitable battery type may come into consideration, such as lithium ion cells, lithium polymer cells, nickel metal hydride cells or lead oxide cells. Furthermore, energy store cells 111 may also be designed based on capacitors.

Battery pack 100 is preferably charged inductively. Inductive charging of accumulator packs or battery packs or terminals, having permanently installed chargeable battery cells, utilizes the magnetic field for energy transmission between the charging station (transmission unit) and the battery pack (receiving unit). In an inductive charging system, electrical interface 120 of battery device 100 includes an inductive receiving coil 121, which transforms a magnetic alternating field, emitted by a transmitting coil 221 of a corresponding electrical interface 220 of charging station 200 into an electric current. As is shown in FIG. 1, transmitting coil 221 of charging station 200 and receiving coil 121 of battery device 100, accommodated in charging station 200, lie directly opposite to each other. In order to achieve as best as possible an inductive coupling of the two coils, the distance between the two coils would typically amount to a few millimeters to centimeters. To improve the inductive coupling between the two coils, ferromagnetic cores may further be provided on both sides.

The alternating voltage provided during the energy transmission from receiving coil 121 of battery device 100 is coupled into energy store device 110 via connecting line 161 and a rectifier 171. In this context, diode 171 also ensures that energy store device 110 is not discharged via electric line 161 after a charging phase. During the energy transmission, the alternating voltage provided by receiving coil 121 is rectified with the aid of rectifier 173, and is additionally supplied via line 163 to capacitor 152 for “energy harvesting”.

In order to control the charging process, the control loop is closed via a communication connection set up between battery device 100 and charging station 200. For this, an internal control and checking device 130, which is connected using an additional connecting line 165 to energy store device 110, continuously ascertains current condition data of battery cell 111 and passes these charging parameters on via a bidirectional data line 167 to communication device 140. As charging parameters, the current battery voltage, the current charging current or the current battery temperature are recorded. For the purpose of energy supply, control device 130 in the present exemplary embodiment is connected via line 162 and rectifier 172 to main current line 161 of battery device 100. Furthermore, for the purpose of energy supply, control device 130 is connected via connecting line 166 to energy supply device 150 or, using a connecting line 163 which connects energy supply device 150 to electrical interface 120.

To close the control circuit, in the present case, a wireless communication connection is set up between battery device 100 and charging station 200, and the charging parameters and the requested control variable are transmitted via this communication connection from the battery pack to the charging station. Communication device 140 of battery device 100 includes essentially a modulator 141, which preferably works in the so-called ISM band (industrial, scientific and medical band), as well as a corresponding transmission antenna 142. Analogously to this, charging station 200 has an internal communication device 240 having a corresponding modulator 241 and a corresponding receiving antenna 242. The charging parameters received by communication device 240 of charging station 200 are passed on via a bidirectional data connection 254 to a control device 230, which actuates a power electronic actuator 210 via line 253, in order to supply transmission coil 221 of electrical interface 220 with energy. Furthermore, power electronic system 210 is connected to the electrical interface via line 252. The current supply of power electronic system 210 is typically ensured via an external input line 251. Control device 230 in this context is preferably developed to actuate power electronics system 210 only if communication interface 240 of charging station 200 receives a corresponding request by communication device 140 of battery device 100. Thereby an energy saving mode of charging station 200 is implemented, in which the magnetic alternating field is generated by inductive transmission coil 221 of charging station 200 only during a charging process.

In battery device 100, the current supply of control and checking device 130 and of communication device 140 takes place during a charging process, preferably with the aid of the electrical energy provided by electrical interface 120 of the battery device. However, since this current source of control device 130 and communication device 140 is only available during a charging process, the energy required for the initial communication with charging station 200 is provided by an internal energy supply device 150, according to the present invention. This energy supply device 150 includes an energy harvesting device 151 and an additional energy store device 152 having at least one rechargeable energy store for the temporary storage of the electrical energy generated with the aid of energy harvesting device 151. A special capacitor is preferably used as the energy store, e.g. a so-called ultracapacitor or supercapacitor.

Energy harvesting device 151 is a device for energy harvesting, that is, for generating electric current from the environment of battery device 100. Strictly speaking, a certain energy form is transformed, such as radiation energy or kinetic energy or another energy form, electrical energy in the present case. As the energy sources in this case, sunlight, vibrations or generally electromagnetic radiation are possibilities. In the exemplary embodiment shown in FIG. 1, energy harvesting device 151 is developed in the form of a photovoltaic cell or a solar cell. It transforms light radiation, such as sunlight 300, to electrical energy. The energy of the solar cell is then coupled via electric line 164 and via diode 174 into capacitor 152.

Other electromagnetic radiation, such as radio waves, may be transformed to an electrical signal with the aid of receiving antennas. From such an electrical signal, an electric voltage for charging additional storage device 152 may be generated, with the aid of relatively simple means. The harvesting of the radiation energy with the aid of receiving antennas does supply a clearly lower energy yield that the use of photovoltaic cells, to be sure, but this energy source is available around the clock, in practice. Furthermore, in order to increase the efficiency of energy harvesting device 151, a plurality of receiving antennas may also be used. The receiving antennas, preferably situated along the housing of the battery device, may each be developed, in this context, for the same radiation or for radiation of different frequencies.

In order to ensure a reliable detection (identification) of the battery device, a redundant and bidirectional transmission may be used.

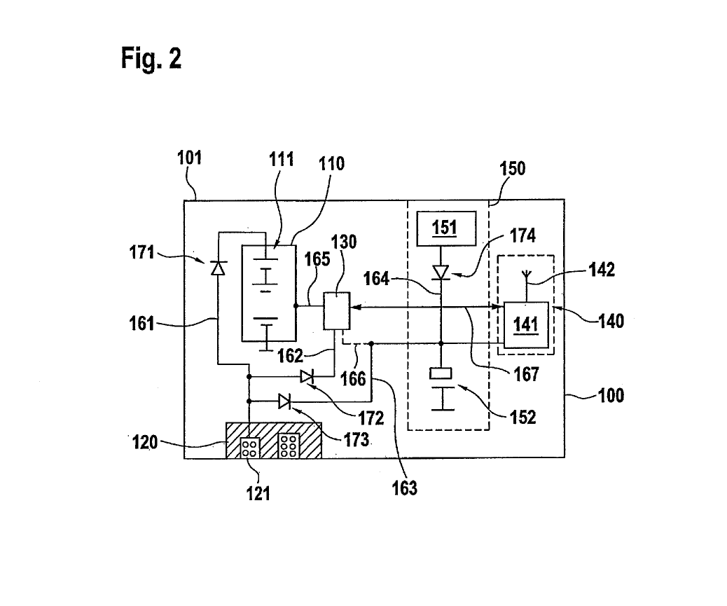

FIG. 2 shows another specific embodiment of battery device 100 according to the present invention. In this variant, energy supply device 150 includes as energy harvesting device 151 a piezoelectric element for generating electrical energy from vibrations of the battery device. In this instance, the piezoelectric effect is utilized, according to which a compression of a piezoelectric crystal effects a potential difference on opposite sides of the crystal. Instead of piezoelectric element 151, in order to extract electrical energy from the motion of battery device 100, an electromagnetic generator may also be used. Such a generator may be developed, in this context, in the form of a coil pack, in which a permanent magnet is movably supported. By the back and forth motion of the permanent magnet, an electric voltage is induced within the coil. The reverse constellation, namely a coil pack that is movable relative to a stationary permanent magnet, leads to a corresponding voltage induction within the coil.

Besides the energy harvesting concepts described in connection with FIGS. 1 and 2, any form of power generation using energy harvesting for the energy supply of communication device 140 or control device 130 may be used. Thus, for example, thermoelectric generators may also be used in order meaningfully to utilize the heat coming up during the operation of the battery device. In the case of such a thermoelectric generator, a thermoelectric component is involved which works according to the inverse Peltier effect. In this instance, the thermoelectric generator converts a temperature difference into an electric voltage. In order to achieve an efficient power generation, the thermoelectric generator, that is typically developed in the form of a thin layer, may be situated as near as possible to the battery cells of the battery device. It is also possible, however, to conduct the heat coming up at the battery cells, for instance, using thermally conductive elements, to a thermoelectric generator situated away from the battery cells.

Although the inventive concept in the above description was described only in connection with exchangeable battery packs or accumulator packs, the present invention basically also relates to permanently installed accumulator cells and battery cells. Furthermore, within the meaning of the present invention, the inventive concept should not be restricted to the known types of battery or accumulator. Basically, any suitable energy store technology should be considered for this purpose that is usable in connection with the inductive charging method described. A plurality of the energy harvesting concepts provided in this document may also be provided in a battery device, in order to implement a particularly efficient power production. Finally, the energy supply using energy harvesting described here is basically also suitable for other concepts of wireless energy transmission between a charging station and a battery device, such as using air coils, capacitively, electromagnetically, etc.

1-12. (canceled)

13. A battery device, comprising:
at least one chargeable battery cell;
an electrical interface for charging the battery cell on an external charging unit;
a communication device for wireless communication with the external charging unit; and
an energy supply device independent of the battery cell and configured to supply energy to the communication device during an initial communication with the external charging unit.

14. The battery device as recited in claim 13, wherein the energy supply device includes an energy harvesting device and an energy store device, the energy harvesting device being configured to obtain electrical energy from the surroundings of the battery device, and the energy store device being configured to store the electrical energy obtained by the energy harvesting device.

15. The battery device as recited in claim 14, wherein the energy harvesting device is configured to transform electromagnetic radiation acting upon the battery device into electrical energy.

16. The battery device as recited in claim 15, wherein the energy harvesting device includes at least one of a photovoltaic cell and a receiving antenna for electromagnetic radiation.

17. The battery device as recited in claim 14, wherein the energy harvesting device is configured to transform a motion of the battery device into electrical energy.

18. The battery device as recited in claim 17, wherein the energy harvesting device includes at least one of a piezoelectric element and an electromagnetic generator.

19. The battery device as recited in claim 14, wherein the energy harvesting device includes a thermoelectric generator.

20. The battery device as recited in claim 14, wherein the electrical interface of the battery device is configured to receive power from a corresponding electrical interface of the charging unit in a wireless manner.

21. The battery device as recited in claim 20, wherein the electrical interface includes an inductive receiving coil for producing an inductive coupling to a corresponding inductive transmission coil of the external charging unit.

22. The battery device as recited in claim 20, wherein the communication device includes a modulator for setting up a wireless communication connection in the ISM band.

23. The battery device as recited in claim 20, wherein the communication device is configured to send charging parameters of the battery cell provided by the control device via the wireless communication connection to the charging unit.

24. The battery device as recited in claim 20, wherein the energy supply device is further configured to supply the control device, in addition to the communication device, with electrical energy.
